(19) United States
(12) Patent Application Publication
(10) Pub. No.: US 2021/0034813 A1
(43) Pub. Date: Feb. 4, 2021

(54) NEURAL NETWORK MODEL WITH EVIDENCE EXTRACTION

(71) Applicant: 3M INNOVATIVE PROPERTIES COMPANY, Saint Paul, MN (US)

(72) Inventors: Xinzi Wu, Sandy, UT (US); Nicolas M. Bertagnolli, Riverton, UT (US); Jimmy, Saint Paul, MN (US)

(73) Assignee: 3M INNOVATIVE PROPERTIES COMPANY, Saint Paul, MN (US)

(21) Appl. No.: 16/940,466

(22) Filed: Jul. 28, 2020

Related U.S. Application Data
(60) Provisional application No. 62/880,927, filed on Jul. 31, 2019.

(51) Int. Cl. G06F 40/20; G10L 15/197; G10L 15/16; G06K 9/62; G06F 17/16

(52) U.S. Cl. CPC G06F 40/20; G10L 15/197; G06F 17/16; G06K 9/6267; G10L 15/16

(57) ABSTRACT

Aspects of the present disclosure relate to a system. The system includes one or more computers having processing circuitry and a memory storing instructions which, when executed by the processing circuitry, cause the processing circuitry to perform operations including determining a labeled classification from a collection of documents corresponding to an encounter. The collection of documents comprises a first plurality of n-grams. The operations also include determining an evidence score for an n-gram based on contribution of the n-gram to the labeled classification, ranking at least some of the first plurality of n-grams based on the evidence score for each n-gram, selecting an n-gram from the first plurality of n-grams as an explanation evidence based on the ranking and performing at least one operation in response to selecting the n-gram.

### BACKGROUND

In the recent years, deep learning, a subfield of machine learning with built-in feature learning capability, has achieved performance break-through in many areas ranging from computer vision to natural language process (NLP), and has been successfully applied to tasks such as text classification, language modeling, speech recognition, caption generation, machine translation, document summarization, question answering, or even medical coding as a code prediction task. Specifically, convolutional neural networks (CNNs), a type of deep-learning model architecture, have achieved competitive accuracy in predicting medical codes from free-text clinical documents.

Convolutional neural networks (CNNs) are particularly well suited to classifying features in data sets modelled in two or three dimensions. This makes CNNs popular for image classification, because images can be represented in computer memories in three dimensions (two dimensions for width and height, and a third dimension for pixel features like color components and intensity). For example, a color JPEG image of size 480×480 pixels can be modelled in computer memory using an array that is 480×480×3, where each of the values of the third dimension is a red, green, or blue color component intensity for the pixel ranging from 0 to 255. Inputting this array of numbers to a trained CNN will generate outputs that describe the probability of the image being a certain class (0.80 for cat, 0.15 for dog, 0.05 for bird, etc.). Image classification is the task of taking an input image and outputting a class (a cat, dog, etc.) or a probability of classes that best describes the image.

Fundamentally, CNNs input the data set, pass it through a series of convolutional transformations, nonlinear activation functions (e.g., RELU), and pooling operations (downsampling, e.g., maxpool), and an output layer (e.g., softmax) to generate the classifications.

Medical coding is the process of assigning standard codes from various classification systems (e.g., CPT, ICD-10-CM, ICD-10-PCS) to patient visits, also known as encounters. It plays an essential role for healthcare providers to obtain timely reimbursement, and directly impacts provider revenue cycles. Medical coding is traditionally performed by a human coder, who examines the information associated with a patient encounter, such as free-text clinical notes, and assigns codes according to coding rules. This manual process is often laborious due to the vast space of possible codes, complex coding rules, and unstructured nature of input data (i.e., free-text clinical documents).

Computer-assisted coding (CAC) solutions aim to streamline a medical coder's workflow and enhance a provider's revenue cycle efficiency by auto-suggesting candidate codes for encounters. These solutions can rely on carefully curated rules by subject matter experts (SMEs), or machine learning techniques using hand-engineered and/or automatically-learned features, or a combination thereof.

While CNNs have been used to classify text, See Yoon Kim, Convolutional neural networks for sentence classification, Proceedings of the 2014 Conference on Empirical Methods in Natural Language Processing, pages 1746-1751 (2014), there is no mechanism to allow a user to point to passages or a particular evidence document based on the determination of a classification.

### BRIEF SUMMARY

Some systems, like those described in US Patent Publication No. 20170185893, discusses a threshold for the confidence value used to determine a classification in a deep-learning model. However, the confidence values are not ranked, and further, the confidence values are not used to highlight n-grams within an evidence document for a user.

When building machine learning models to predict medical codes associated with a clinical encounter for billing purposes, evidence supporting predicted codes are mandatory to meet regulatory requirements and gain user acceptance.

Aspects of the present disclosure relate to a system. The system includes one or more computers having processing circuitry and a memory storing instructions which, when executed by the processing circuitry, cause the processing circuitry to perform operations including determining a labeled classification from a collection of documents corresponding to an encounter. The collection of documents comprises a first plurality of n-grams. The operations also include determining an evidence score for an n-gram based on contribution of the n-gram to the labeled classification, ranking at least some of the first plurality of n-grams based on the evidence score for each n-gram, selecting an n-gram from the first plurality of n-grams as an explanation evidence based on the ranking and performing at least one operation in response to selecting the n-gram.

Aspects of the present disclosure relate to a method. In at least one embodiment, the method is implemented on one or more computers at processing speeds of less than 2 seconds for 10 documents. The method can include accessing a collection of documents corresponding to an encounter, a document in the collection of documents can include a first plurality of n-grams. The method can also include applying the first plurality of n-grams to a neural network model to obtain a labeled classification for the document. The method can also include determining an explanation evidence based on a group of n-grams existing after a pooling operation in a pooling layer of the neural network model. The method can also include displaying the explanation evidence relevant to determination of the labeled classification by the neural network model. The explanation evidence is a group of n-grams.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with one embodiment.

FIG. 2 illustrates a neural network model 200 in accordance with one embodiment.

FIG. 3 depicts an illustrative computer system architecture that may be used in accordance with one or more illustrative aspects described herein.

FIG. 4 illustrates a routine 400 in accordance with one embodiment.

FIG. 5 illustrates a subroutine block 500 in accordance with one embodiment.

FIG. 6 illustrates a subroutine block 700 in accordance with one embodiment.

FIG. 7 illustrates a subroutine block 700 in accordance with one embodiment.

FIG. 8 illustrates a table 800 in accordance with one embodiment.

FIG. 9 illustrates a table 900 in accordance with one embodiment.

FIG. 10 illustrates a table 1000 in accordance with one embodiment.

FIG. 11 illustrates a table 1100 in accordance with one embodiment.

### DETAILED DESCRIPTION

“Clinical code” refers to a code used to describe medical, surgical, and diagnostic services rendered to a patient. Clinical codes can include the International Classification of Diseases (ICD) (e.g., 10th revision) and the Current Procedural Terminology (CPT) published by the American Medical Association (e.g., CPT 2018).

“Clinician” refers to a medical professional having direct contact with and responsibility for patients, includes doctors, nurses, and support staff therefrom.

“Compliance evidence” refers to evidence that is similar (i.e., can be matched within a margin of error) to a code description for a clinical code. The compliance evidence conforms to coding rules specific to a predicted code, and serves to satisfy regulatory requirements and build user trust in model predictions. The compliance evidence can be a type of explanation evidence.

“Computer” refers to any single machine or combination of machines that includes processing circuitry and memory. Computer may include one or more of a server, a client device, a desktop computer, a laptop computer, a mobile phone, a tablet computer, a personal digital assistant (PDA), a smart television, a smart watch, and the like. As used herein, the phrases “computing machine,” “computing device,” and “computer” encompass their plain and ordinary meaning.

“Encounter” refers to a documented meeting between persons and involving one or more procedures between persons.

“Evidence” refers to information indicating that a result obtained is valid. Evidence may be used to refer to multiple groups of evidence. For example, if the evidence is multiple text strings in multiple documents (these evidences may collectively be referred to as evidence), then these text strings can be the evidence for a returned clinical code.

“Evidence score” refers to a likelihood that a labeled classification exists given that the n-grams are present. The evidence score can be tied to a specific labeled classification.

“Explanation evidence” refers to evidence corresponding to the determination of a labeled classification by a deep-learning model. For example, the explanation evidence explains how the model derives a particular prediction. Explanation evidence provides transparency of the model's inner work and offers valuable insights for analyzing erroneous predictions made by the model.

“Group of n-grams” refers to n-grams selected by a pooling operation for a given clinical code

“Labeled classification” refers to a category in which data is put. The labeled classification has a label to define the category. A clinical code is a type of labeled classification.

“N-gram” refers to a sequence of N words.

“Network” refers to systems in which remote storage devices are coupled together via one or more communication paths, and also to stand-alone devices that may be coupled, from time to time, to such systems that have storage capability. Consequently, the term “network” includes not only a “physical network” but also a “content network,” which is comprised of the data—attributable to a single entity—which resides across all physical networks. The term network can also encompass a neural network which may be hosted on stand-alone devices.

“Pre-defined evidence” refers to evidence that is identified by subject matter experts.

“Training set of data” refers to a series of raw text documents and the codes that are associated with the collection of documents.

“Vector representation” refers to numbers that represent the meaning of a word. May also be d-dimensional intensity vectors including any suitable values in the range of −1 to 1.

Aspects of the present disclosure describe a system, method, and computer program product to extract evidence from a deep neural network model trained to predict labeled classifications. When presented with free-text documents from an encounter and a trained deep neural network model capable of taking the documents as input and producing predicted labeled classifications, the system can extract spans of text from the documents as evidence for explaining the labeled classifications made by the deep neural network model.

In addition, if a pre-defined evidence compliant with the labeled classification rules for a predicted code are available, the disclosed method and system can also extract spans of text most similar to the pre-defined evidence from the documents. Thus, the system can “trace” and hence explain how spans of text from input (e.g., clinical) documents contribute to a code prediction by a deep neural network model and identify spans of text from the documents best matching compliance evidence based on a similarity metric between free-text segments.

Although embodiments focus on the clinical coding domain, the approach is general and can be applied to other areas where evidence are needed to support deep neural network model predictions from free-text input. One such area may be predicting adverse healthcare outcomes (e.g., readmission) from free-text clinical notes created during a patient encounter using a deep neural network model. In such an application, often the user may need to know not only whether a patient will likely experience an adverse outcome, but also why the patient is at risk in order to implement appropriate intervention.

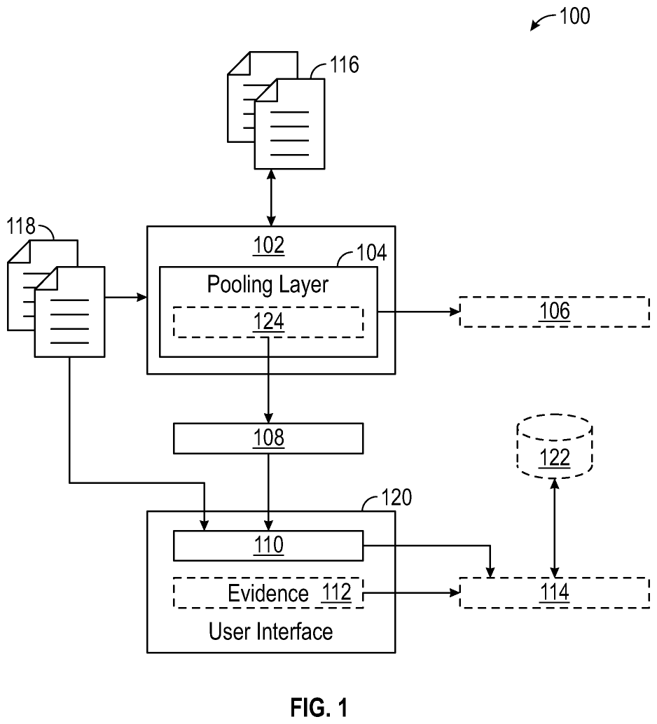

FIG. 1 illustrates a system 100, according to various embodiments. The system 100 can include a neural network model 102.

A neural network, sometimes referred to as an artificial neural network (ANN), is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the ANN processing.

The correct operation of most ANNs relies on correct weights. However, ANN designers do not generally know which weights will work for a given application. Instead, a training process is used to arrive at appropriate weights. ANN designers typically choose a number of neuron layers or specific connections between layers including circular connection, but the ANN designer does not generally know which weights will work for a given application. Instead, a training process generally proceeds by selecting initial weights, which may be randomly selected. Training data is fed into the ANN and results are compared to an objective function that provides an indication of error. The error indication is a measure of how wrong the ANN's result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In at least one embodiment, the neural network model 102 is preferably a trained CNN model as described herein. For example, the neural network model 102 can be the neural network model 200 trained using a training set of data 116 (e.g., data that is labeled based on a particular training set of labeled classifications).

In the system 100, the collection of documents 118 that are associated with a medical encounter can be pre-processed and input into the neural network model 102, which is capable of predicting labeled classification 106 from the collection of documents 118. In at least one embodiment, in addition to the labeled classification 106, the system 100 can output a ranked list of explanation evidence 110 using an evidence extraction module 108 to explain the predicted labeled classification 106. Although references to a determination of a clinical code are made, the methodology of the present disclosure can also be applicable to any multi-label classification output from a neural network model and not exclusively labels pertaining to only clinical codes.

For example, in addition to the labeled classification 106, the system 100 can also provide the evidence extraction module 108 with a group of n-grams 124 from the pooling layer 104 that contributed most to the labeled classification 106. The group of n-grams 124 can be the n-grams selected for a given clinical code as a result of a pooling operation (e.g., a max-pooling operation).

In at least one embodiment, the contribution (i.e., evidence score) of an n-gram is calculated as the product of its convolution output value with the corresponding weight in the output layer, which is the actual value that this n-gram contributes to the raw unnormalized prediction for the code. The evidence score can be determined as a result of the convolutional operation. Thus, avoiding another processing step. The evidence extraction module 108 can produce an evidence score for an n-gram from the group of n-grams 124 that correspond to the labeled classification 106. In at least one embodiment, the same n-gram may be selected multiple times by the pooling layer from different filters. In this case, the contribution of the n-gram is taken as the pooled value (e.g., max or mean value) among its evidence scores.

In one example, the contribution of a candidate n-gram identified via max-pooling to the final prediction of the clinical code can be either positive or negative. If the contribution, captured by the evidence score, is negative, this n-gram actually makes the prediction less likely. In this case, it may not be appropriate to surface this n-gram as an explanation evidence 110. Similarly, the evidence score of an n-gram can be close to zero, in which case the n-gram has little effect on the prediction and again should not be presented as an explanation evidence 110.

In at least one embodiment, the evidence extraction module 108 can also rank the n-grams from the group of n-grams 124 based on the evidence score. The candidate explanation evidence can now be ranked according to the evidence scores, with higher ranks for higher evidence scores. Thus, the explanation evidence 110 ranked highest can also make the largest contribution to the predicted probability of the labeled classification 106. To extract explanation evidence for a predicted code, the top n-ranked explanation evidence 110 can be presented to a user via a user interface 120, with n being a pre-determined number (such as 10) or a user-specified number.

In at least one embodiment, the evidence extraction module 108 can be optionally passed through a similarity module 114 which can condition the explanation evidence 110. For example, the similarity module 114 can use a plurality of pre-defined evidence 122 curated to be compliant with the coding rules for the labeled classification 106 to determine the similarity of the n-gram with a clinical code (even one not determined by the neural network model 102). The input plurality of pre-defined evidence 122 can be expressed as spans of text, such as words, phrases, or sentences, and are likely curated by subject matter experts. For simplicity and clarity, FIG. 1 shows the evidence extraction for a single predicted labeled classification 106. If multiple clinical codes are predicted for an encounter, the evidence extraction process is repeated for each predicted labeled classification 106.

In one embodiment, the similarity module 114 can output another ranked list of compliance evidence 112 that best match the plurality of pre-defined evidence 122, with higher ranks for better matches.

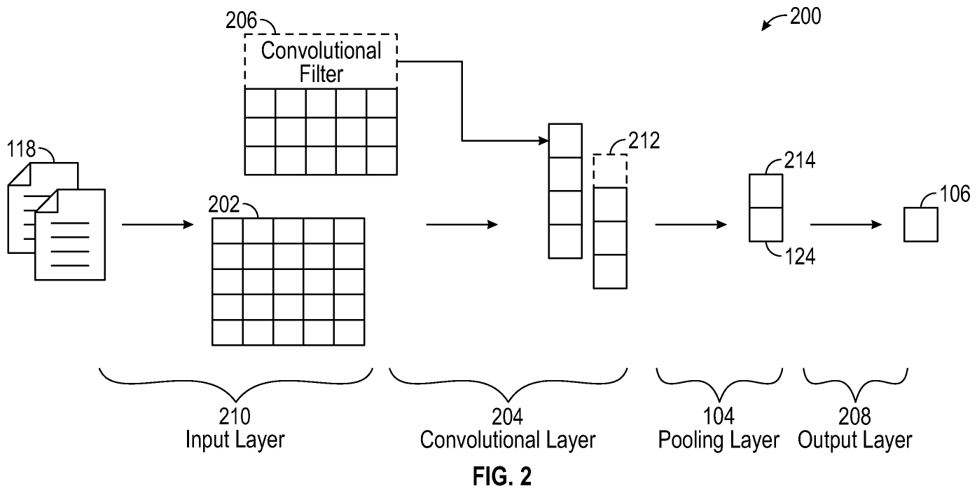

FIG. 2 illustrates a neural network model 200. The neural network model 200 can be a specific type of DNN model.

Convolutional neural networks are initially designed for and applied to computer vision tasks, such as image recognition. This type of neural network has been successfully applied to classification tasks with free-text input, such as sentiment classification of product reviews. There are many different architecture variations among CNNs. The neural network model 200 can be similar to the example CNN models described by Yoon Kim, Convolutional neural networks for sentence classification, Proceedings of the 2014 Conference on Empirical Methods in Natural Language Processing, pages 1746-1751 (2014) and James Mullenbach, Sarah Wiegreffe, Jon Duke, Jimeng Sun, and Jacob Eisenstein, Explainable prediction of medical codes from clinical text, Proceedings of National Association for Computational Linguistics: Human Language Technologies, pages 1101-1111 (2018), which are incorporated by reference.

At a high level, CNN architecture can feed tokenized input text into an input layer 210. A convolutional layer with multiple filters is applied over the input layer 210. The outputs from the convolutional layer are combined via pooling layer 104. And finally, the pooling layer 104 is connected to a fully-connected output layer 208 or projection layer to produce predicted probabilities for different classes that are of interest in a classification task. When applying this CNN model architecture to predict clinical codes, all the clinical documents from a single encounter can be concatenated into a combined document and tokenized into individual words. The outputs from the CNN model are predicted probabilities for clinical codes.

For example, the neural network model 200 can receive a text input from a collection of documents 118 at the input layer 210. The collection of documents 118 can be associated with one or more occurrences of a patient visit (but preferably a single occurrence of the patient visit).

According to some aspects, the collection of documents 118 can correspond to a medical encounter and a labeling for the collection. The labeling includes zero or more labels. Thus, the collection of documents 118 can be unlabeled before being passed through the neural network model 200. In at least one embodiment, some of the collection of documents 118 can be labeled. The label(s) can represent medical annotations (e.g. medical billing codes or medical concepts) assigned to the medical encounter. The collection of documents corresponds to a medical encounter, and the labeling represents medical annotations assigned to the medical encounter. However, the technology disclosed herein is not limited by these implementations. In alternative implementations, the collection of documents may correspond to any collection of documents and the labels may be any labels. In one example, the collection of documents corresponds to a legal document review project, and the labeling represents annotations assigned to the legal document review project. In one example, the collection of documents corresponds to a virtual book repository, and the labeling represents categories of books. In one example, the collection of documents corresponds to online posts, and the labeling represents tags of the online posts. Those skilled in the art may devise other things to which the collection of documents may correspond and/or other things which the labeling may represent.

In one example, the collection of documents 118 can correspond to multiple patient visits at a particular medical facility. After the collection of documents 118 is accessed, then the text input from each of the documents from the collection of documents 118 can be tokenized and result in first plurality of n-grams 202. In at least one embodiment, the first plurality of n-grams can be associated with a single document from the collection of documents 118 or from a plurality collection of documents 118 from the collection of documents 118.

At convolutional layer 204, a convolutional filter 206 or convolutional kernel can further be applied to the first plurality of n-grams 202 to obtain a plurality of features. The convolutional filter 206 serve as feature detectors over n-grams with n equal to the filter width. When a convolutional filter 206 is applied to the convolutional filter 206 via the convolution operation, an output value is computed for each n-gram. In at least one embodiment, the convolutions can result in a matrix of features 212. In at least one embodiment, the neural network model 200 can include only a single level of convolutions. For example, convolutional layer 204 can perform one layer of convolutions.

In at least one embodiment, the convolution outputs for all the n-grams (e.g., matrix of features 212) are then fed to the pooling layer 104. In at least one embodiment, the one or more computers can evaluate the plurality of features, at the pooling layer 104, to obtain the vector representation based on a clinical code for the first plurality of n-grams. For example, the matrix of features 212 from one or more convolutions can be subjected to pooling operations at the pooling layer 104 to obtain a vector representation for each label (e.g., clinical code).

Examples of pooling operations include max-pooling, or mean pooling. For example, a softmax operator can be used on matrix of features 212 to obtain vector representation 214 for each matrix of features. The vector representation 214 can be a probability of matching the labeled classification 106. In at least one embodiment, only the highest convolution output value from the convolutional filter 206 can be passed to the output layer 208 and used to compute the predicted probability of a labeled classification 106. The pooling layer 104 can effectively act as a feature selector, which selects a one or more n-grams (group of n-grams 124) with the highest convolution output value to contribute to the final predicted labeled classification 106.

In a CNN model, there are multiple filters in the convolutional layer 204. The pooling layer 104 ends up selecting multiple n-grams, with one n-gram per filter, to use for predicting codes. Since only the n-grams selected via max-pooling can affect code prediction, these are the n-grams that can serve as candidate explanation evidence (described herein).

At the output layer 208, the output of the neural network model 200 can be the most likely labeled classification 106 for the collection of documents 118.

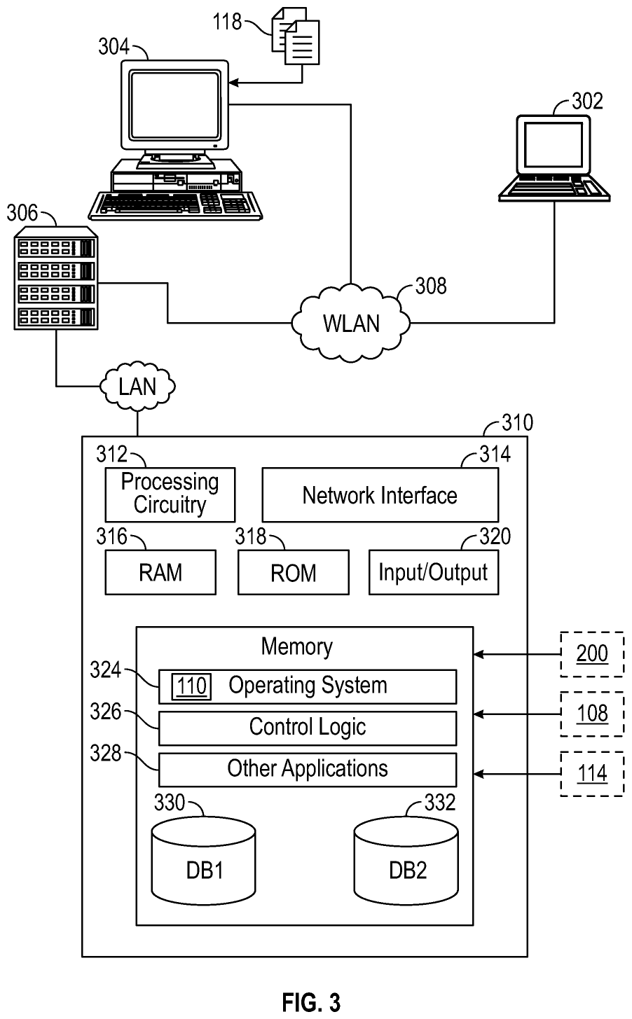

FIG. 3 illustrates one example of a system architecture and data processing device that may be used to implement one or more illustrative aspects described herein in a standalone and/or networked environment. Various network nodes computer 310, web server 306, computer 304, and laptop 302 may be interconnected via a wide area network 308 (WAN), such as the internet. Other networks may also or alternatively be used, including private intranets, corporate networks, LANs, metropolitan area networks (MANs) wireless networks, personal networks (PANs), and the like. Network 308 is for illustration purposes and may be replaced with fewer or additional computer networks. A local area network (LAN) may have one or more of any known LAN topologies and may use one or more of a variety of different protocols, such as Ethernet. Computer 310, web server 306, computer 304, laptop 302 and other devices (not shown) may be connected to one or more of the networks via twisted pair wires, coaxial cable, fiber optics, radio waves or other communication media.

The components may include computer 310, web server 306, and client computer 304, laptop 302. Computer 310 provides overall access, control and administration of databases and control software for performing one or more illustrative aspects described herein. Computer 310 may be connected to web server 306 through which users interact with and obtain data as requested. Alternatively, computer 310 may act as a web server itself and be directly connected to the internet. Computer 310 may be connected to web server 306 through the network 308 (e.g., the internet), via direct or indirect connection, or via some other network. Users may interact with the computer 310 using remote computer 304, laptop 302, e.g., using a web browser to connect to the computer 310 via one or more externally exposed web sites hosted by web server 306. Client computer 304, laptop 302 may be used in concert with computer 310 to access data stored therein or may be used for other purposes. For example, from client computer 304, a user may access web server 306 using an internet browser, as is known in the art, or by executing a software application that communicates with web server 306 and/or computer 310 over a computer network (such as the internet).

Servers and applications may be combined on the same physical machines, and retain separate virtual or logical addresses, or may reside on separate physical machines. FIG. 3 illustrates just one example of a network architecture that may be used, and those of skill in the art will appreciate that the specific network architecture and data processing devices used may vary, and are secondary to the functionality that they provide, as further described herein. For example, services provided by web server 306 and computer 310 may be combined on a single server.

Each component, e.g., computer 310, web server 306, computer 304, laptop 302 may be any type of known computer, server, or data processing device.

Computer 310, e.g., may include a processing circuitry 312 controlling overall operation of the computer 310. Computer 310 may further include RAM 316, ROM 318, network interface 314, input/output interfaces 320 (e.g., keyboard, mouse, display, printer, etc.), and memory 322. Input/output interfaces 320 may include a variety of interface units and drives for reading, writing, displaying, and/or printing data or files. Memory 322 may further store operating system software 324 for controlling overall operation of the computer 310, control logic 326 for instructing computer 310 to perform aspects described herein, and other application software 328 providing secondary, support, and/or other functionality which may or may not be used in conjunction with aspects described herein. In at least one embodiment, the operating system software 324 can be include a graphical user interface that can be used to display the explanation evidence 110 or compliance evidence 112 based on a collection of documents. In at least one embodiment, the operating system software 324 can be responsible for the operation of any component of system 100.

The control logic may also be referred to herein as the data server software control logic 326. Functionality of the data server software may refer to operations or decisions made automatically based on rules coded into the control logic, made manually by a user providing input into the system, and/or a combination of automatic processing based on user input (e.g., queries, data updates, etc.).

Memory 322 may also store data used in performance of one or more aspects described herein, including a first database 332 and a second database 330. In some embodiments, the first database may include the second database (e.g., as a separate table, report, etc.). That is, the information can be stored in a single database, or separated into different logical, virtual, or physical databases, depending on system design. In at least one embodiment, the first database 332 can store the collection of documents 118 and the second database 330 can store the training set of data.

For example, the computer 304 can be at a remote site (such as a hospital administrator site) and upload the collection of documents 118 for analysis. The collection of documents 118 can be pre-processed locally on computer 304 or uploaded to first database 332 then pre-processed by processing circuitry 312. The neural network model 200, evidence extraction module 108, or similarity module 114 can be hosted by the computer 310 or any other computer, e.g., web server 306. In particular, neural network model 200 can include artificial neurons or neural network nodes that may be separately hosted on various computers interconnected via the LAN or WLAN.

The computer 310 can communicate both the labeled classification determined from the collection of documents 118 and the explanation evidence 110 determined by the evidence extraction module 108 or conditioned by the similarity module 114 to the computer 304. In at least one embodiment, only the n-grams are transmitted as the explanation evidence 110 and then the computer 304 can modify the local instances of the collection of documents 118 to highlight the explanation evidence 110. Doing so can save processing load on the computer 310. In at least one embodiment, the entire collection of documents 118 or relevant documents from the collection of documents 118 are transmitted from computer 310 to computer 304 with explanation evidence 110 highlighted.

Web server 306, computer 304, laptop 302 may have similar or different architecture as described with respect to computer 310. Those of skill in the art will appreciate that the functionality of computer 310 (or web server 306, computer 304, laptop 302) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processing circuitry in a computer or other device. The modules may be written in a source code programming language that is subsequently compiled for execution or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

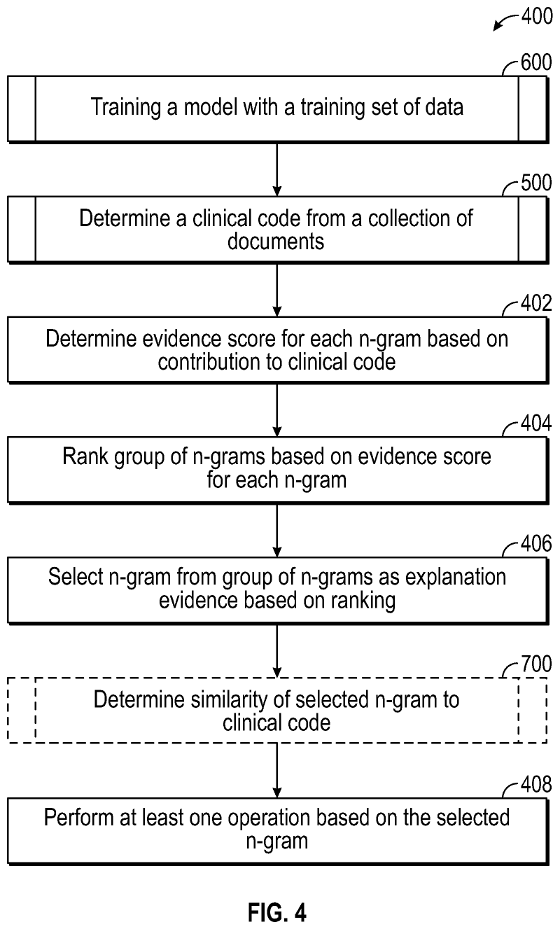

FIG. 4 illustrates a routine 400 for analyzing a collection of documents. The routine 400 can be executed by a computer such as computer 310 having a processing circuitry and a memory. In at least one embodiment, various nodes or neurons can be hosted on various computers for distributed computing architecture.

The routine 400 can begin at subroutine block 600. The computer can use a convolutional neural network (CNN) model to train with a corpus of data including various collection of documents relating to a medical instance. The collection of documents in the training set of data is labeled with one or more clinical codes. In at least one embodiment, a computer can access an ordered set of labels (e.g., clinical code) and a training set of documents. At least a portion of the documents in the training set of data are labeled with one or more labels from the ordered set of labels. The set of labels is ordered by number of documents to which each label is assigned, with the labels having the largest number of documents occurring first. The computer trains, using the training set of documents, a first document-label association module to identify documents associated with a first label from the ordered set of labels. This training could be accomplished, for example, using supervised learning. The computer trains, using the training set of data, a second document-label association module to identify documents associated with a second label from the ordered set of labels. The second document-label association module is initialized based on the trained first document-label association module. The computer provides, as a digital transmission (e.g. to a second computer different from the first computer), a representation of a combined document-label association module, which includes the first document-label association module and the second document-label association module.

After subroutine block 600, the routine 400 can continue to subroutine block 500. In subroutine block 500, the computer can determine a clinical code from a collection of documents corresponding to a patient encounter. For example, the collection of documents can be tokenized and input into the (trained) neural network model. The output can be one or more clinical codes based on the collection of documents. In at least one embodiment, the clinical code can be based on a single document from the collection of documents or a plurality of documents from the collection of documents.

In block 402, the computer can determine an evidence score for each n-gram based on contribution to the clinical code. Specifically, the computer can use the inputs to the pooling layer of a neural network model to determine the evidence score. For example, the evidence score can be a product of an n-gram convolution output value with the corresponding weight of the neural network node in the output layer. Thus, the evidence score can be the actual value that a particular n-gram contributes to the raw unnormalized prediction for the clinical code. In at least one embodiment, the evidence score is assigned to a word vector.

In at least one embodiment, the contribution of a candidate n-gram identified via max-pooling to the final prediction can be either positive or negative. If the contribution, captured by the evidence score, is negative, this n-gram actually makes the prediction less likely. Similarly, the evidence score of an n-gram can be close to zero, in which case the n-gram can have little effect on the prediction and again should not be presented as an explanation evidence.

In block 404, once the evidence score is determined for each n-gram based on the clinical code, then the group of n-grams can be ranked by the computer based on the evidence score for each n-gram based on the clinical code. In at least one embodiment, the computer can rank all or some of the group of n-grams. This can occur in parallel with or after operation of the neural network model in subroutine block 500. For example, the evidence score can be determined before, during, or after, the determination of the vector representation for a clinical code.

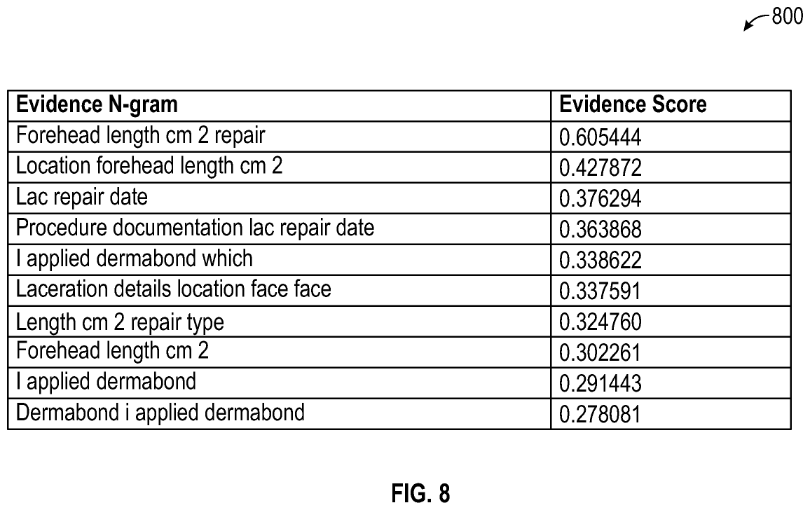

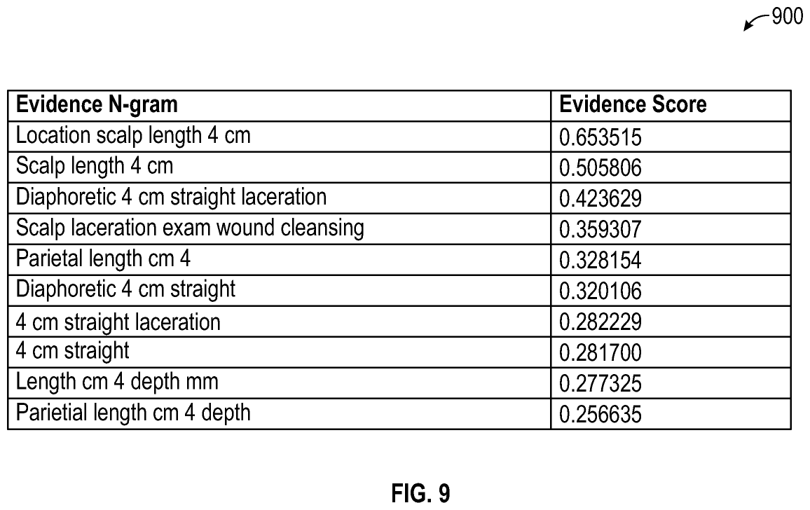

As an example, FIG. 8 and FIG. 9 illustrate exemplary evidence scores for n-grams corresponding to clinical codes.

FIG. 8 illustrates a table 800. Table 800 shows top 10 explanation evidence extracted using the method described in this section for an encounter with correctly predicted CPT code of 12011. The description for CPT code 12011 is “simple repair of superficial wounds of face, ears, eyelids, nose, lips and/or mucous membranes; 2.5 cm or less”. As shown, the n-gram “forehead length cm 2 repair” is shown as having the highest evidence score. Thus, at least the n-gram “forehead length cm 2 repair” can be selected as explanation evidence.

FIG. 9 illustrates a table 900. Table 900 lists top 10 explanation evidence for an encounter with correctly predicted CPT code of 12002. The CPT code 12002 is described as “simple repair of superficial wounds of scalp, neck, axillae, external genitalia, trunk and/or extremities (including hands and feet); 2.6 cm to 7.5 cm”. The n-gram “location scalp length 4 cm” is shown as having the highest evidence score and can be selected as explanation evidence. In at least one embodiment, any user defined rank order can be selected as explanation evidence.

Returning to FIG. 4, in block 406, the computer can select a number of n-grams from the group of n-grams as explanation evidence based on the ranking previously determined. In at least one embodiment, the number is predetermined. For example, the computer can select the top five n-grams from the group of n-grams. In at least one embodiment, the number is based on a proportion of the group of n-grams. For example, the top ten percent of all n-grams from the group of n-grams can be selected. In at least one embodiment, the number is based on a threshold value of evidence scores. For example, if the threshold value of evidence scores is 0.1, then any value of evidence scores less than 0.1 from the group of n-grams could be excluded. The explanation evidence can be derived from the n-grams that have the highest score in the pooling layer (e.g., max-pooling layer) of the neural network model.

In subroutine block 700, the computer can determine the similarity of an n-gram from the group of n-grams to a defined clinical code.

Explanation evidence best for explaining a model prediction for a clinical code may not be the best evidence that conforms with the coding rules for this code. For example, there may be a procedure that is commonly used to treat a particular medical condition such as laceration repair. The medical condition can be predictive for the procedure. If a neural network model is trained with a corpus of documents containing frequent co-occurrences of the procedure and the medical condition, then the neural network model can learn to make use of the medical condition when predicting the code for the procedure. N-grams containing the medical condition can therefore be extracted as top explanation evidence. However, there may be specific coding rules for this procedure code that disallow using the medical condition as an evidence for the code.

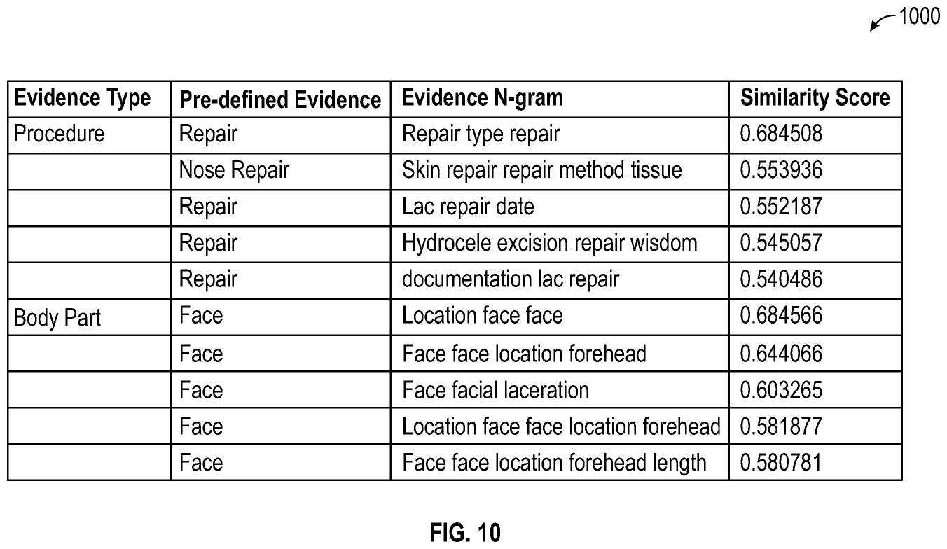

FIG. 10 illustrates a table 1000 which shows the top compliance evidence extracted from the clinical documents of an encounter with correctly predicted CPT code of 12011. This example assumes that the coding rules for 12011 require one procedure evidence from the following list: “nose repair”, “repair”, “simple repair of wounds of face and ears”; and one body part evidence from the following list: “nasal”, “blepharon”, “face”, “entire nose”. Thus, the document containing both n-grams “repair type repair” and “location face face” would be compliance evidence for CPT code 12011.

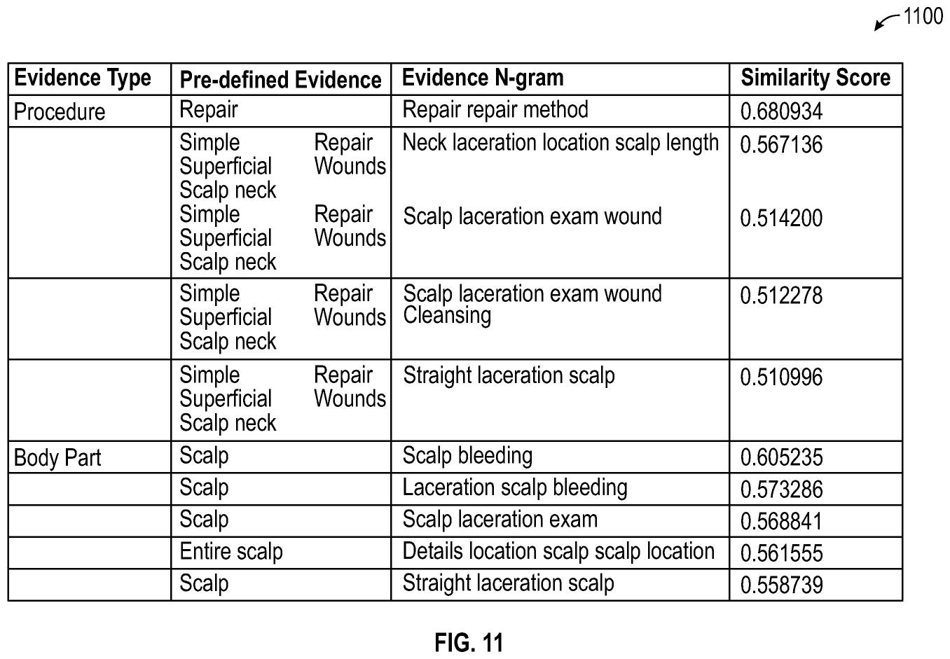

FIG. 11 illustrates a table 1100 which displays top compliance evidence for an encounter with correctly predicted CPT code of 12002. In this example, the coding rules for 12002 are assumed to require one procedure evidence from the following list: “simple repair of superficial wounds of scalp and neck”, “simple repair of wounds of skin of trunk”, “repair of trunk”, “neck repair”, “repair”, “simple repair of wounds of extremities”; and one body part evidence from the following list: “entire scalp”, “external genitalia”, “entire trunk”, “arms and legs”, “entire neck”, “cervical”, “feet”, “genital organ”, “scalp”, “structure of trunk”. Thus, a document containing both n-grams “repair repair method” and “scalp bleeding” can be selected as compliance evidence for CPT code 12002.

In at least one embodiment, any combination of n-grams from the explanation evidence can be used to determine compliance evidence. For example, in table 1100, the combination of “repair repair method” (with a high similarity score) and “straight laceration scalp” (with a lower similarity score) within a single document can be evidence for CPT code 12002.

Once the n-grams that contributed to the identification of the clinical code is identified, then the routine 400 can continue to block 408. In block 408, the computer can perform at least one operation based on the selected n-gram.

Preferably, the computer can access a database or data store with the collection of documents stored therein and provide the collection of documents to a client device with visual identification of the explanation evidence or compliance evidence on the collection of documents. In at least one embodiment, the computer can transmit the explanation evidence or compliance evidence to another client device such that the client device causes visual identification of the n-gram within a document. In at least one embodiment, the computer can cause any or all of the plurality of explanation evidence to be visually identified within a document from the collection of documents.

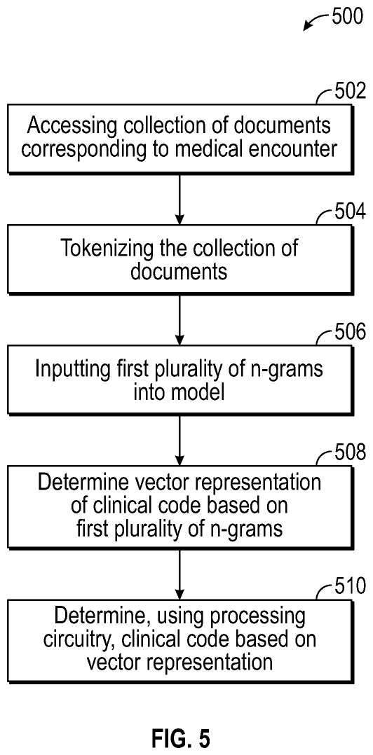

FIG. 5 illustrates a subroutine block 500 for obtaining a clinical code from a collection of documents.

In block 502, the computer can access a collection of documents corresponding to a medical encounter. The collection of documents can include a first plurality of n-grams. In at least one embodiment, each document from the collection of documents can have a different plurality of n-grams.

In at least one embodiment, subroutine block 500 can begin by receiving a request from a first entity. In at least one embodiment, the request can be conditioned upon receiving a collection of documents (e.g., from a client device). The request may alternatively be in the form of a table, database structure, or other format and may include alphanumeric text, such as language text, numbers, and other information. The first entity may be a health care provider, such as a clinic or hospital, or a department within the provider.

In block 504, the computer can tokenize the collection of documents to form the first plurality of n-grams. For example, converting the collection of documents can include optical character recognition, and separating punctuation marks from text in the request and treating individual entities as tokens. The conversion may take the form of tokenization. Tokenization may assign numeric representations to words or individual letters in various embodiments to create a vectorized representation of the tokens. Punctuation may also be tokenized. By assigning numbers via the conversion, the request is placed in a form that a computer can more easily process. For example, a tokenized input having multiple features can be created. Features may be extracted from the neural network model by various methods. The features may be identified as being helpful in obtaining approval of a request to allow the first entity to modify a request before submitting the request to the second entity for approval. In one example, feature extraction is performed by using frequency—inverse document frequency to form a vectorized representation of the tokens. In a further example, features are extracted using a neural word embedding model such as Word2Vec, GloVe, BERT, ELMO, or a similar model.

In block 506, the first plurality of n-grams (tokenized input) is provided to the machine learning system. The tokenized input is provided to a neural network model that has been trained based on a training set of data using clinical code assignments by the first entity. In various examples, the neural network model is a deep neural network model and preferably a convolutional neural network, and even more preferably having a single layer depth. An example of a CNN model is described further by Mullenbach et. al.

For example, the first plurality of n-grams can be subjected to a convolutional operation. The convolutional operation is performed using a plurality of convolution kernels and a feature extraction operation is performed using an activation function at the neuron to obtain a plurality of feature vectors (e.g., in a matrix). Preferably, the activation function can be a rectified linear unit (ReLU) which allows for non-linearities.

Then, a pooling operation can be used. The pooling operation can perform secondary extraction of features. The pooling operation selects an attention vector for each label (e.g., clinical code) that can be based on a matrix-vector product for the clinical code passed through a softmax operator.

In block 508, the computer, using the CNN model, can determine a vector representation for a label based on the first plurality of n-grams. For example, the vector representation can be the product of an attention vector with a matrix of features. In at least one embodiment, using a max-pooling architecture in the pooling layer, the matrix of features can be mapped directly to the vector representation by maximizing over each dimension.

In block 510, the computer can determine the probability of a clinical code based on the vector representation as described in Mullenbach et. al. The probability can vary depending on the clinical code evaluated.

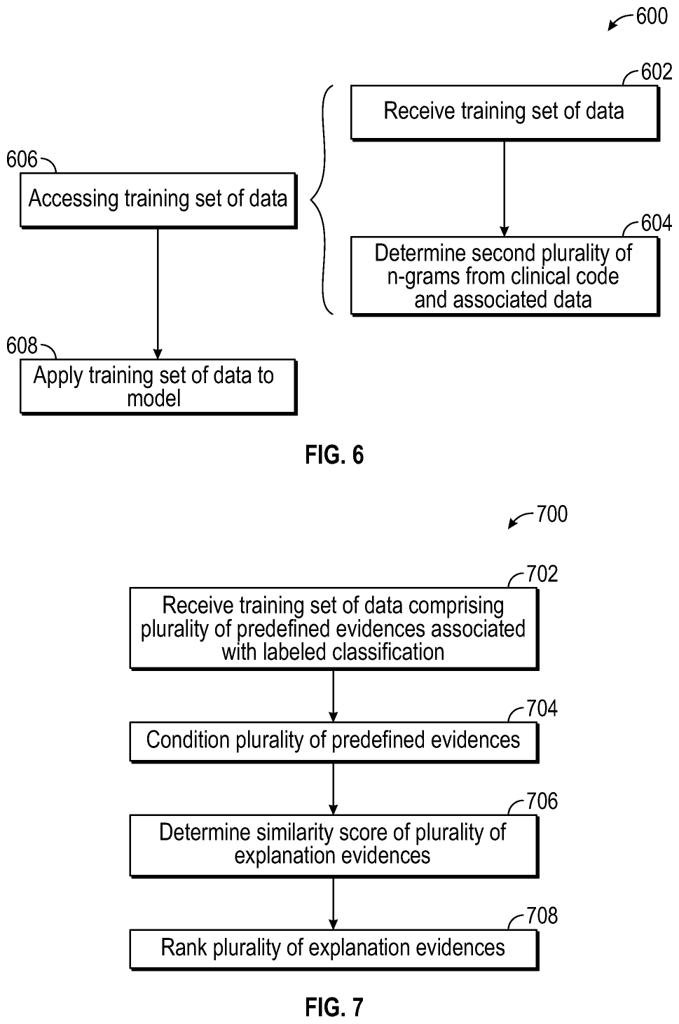

FIG. 6 illustrates a subroutine block 600 for training the neural network model. The subroutine block 600 can generally include accessing a training set of data in block 606, then applying the training set of data to the model in block 608.

Block 606 can also include block 602 where a computer receives the training set of data. The training set of data can be a collection of documents that is associated with one or more known multi-labeled classifications. The training set of data can be a series of raw text documents.

According to some aspects, the training set of data can correspond to a medical encounter and a labeling for the collection. The labeling includes one or more (or zero or more) labels. In at least one embodiment, the label(s) represent medical annotations (e.g. medical billing codes or medical concepts) assigned to the medical encounter. The training set of data corresponds to a medical encounter, and the labeling represents medical annotations assigned to the medical encounter. However, the technology disclosed herein is not limited by these implementations.

In block 604, the computer can pre-process the training set of data to obtain a second plurality of n-grams. The training set of data can be conditioned similarly to block 506. In at least one embodiment, the pre-processing of the training set of data can be optional since the training set of data may already be received in a pre-processed state.

In block 608, the computer can apply the training set of data to the model where the weights and biases of the model are adjusted based on the known labeled classification (e.g., clinical code).

The training of subroutine block 600 can be performed once. Thus, additional training between instances of the model does not occur. In at least one embodiment, the computer can process approximately 1000 pages of text within 10 seconds in subroutine block 600.

FIG. 7 illustrates a subroutine block 700 for determining similarity of a selected n-gram to a labeled classification (e.g., clinical code). subroutine block 700 can begin at block 702.

In block 702, the computer can receive another training set of data that includes pre-defined evidence associated with the clinical code. In at least one embodiment, the selection of the pre-defined evidence can be based on the clinical code evaluated by the model. For example, if clinical code 12010 is evaluated by the CNN model, then only the description for clinical code 12010 is fetched.

The pre-defined evidence can conform with coding rules and can be curated by subject matter experts. The pre-defined evidence can be specified as spans of text, such as words, phrases, or sentences. Given a pre-defined set of such evidence for a predicted code, a similarity metric can be calculated between the pre-defined evidence and candidate text spans extracted from the input clinical documents to identify those text spans most similar to the pre-defined evidence.

To identify candidate text spans, a brute-force approach can generate all unigrams, bigrams, trigram, etc., up to n-grams with a pre-determined n from the input documents as the candidate text spans. However, this approach can result in a huge number of candidate text spans, and hence may not be practical to implement and apply. In at least one embodiment, the n-grams selected by the max-pooling layer can serve as candidate text spans. Besides reducing the candidate text spans to a manageable size, this approach connects compliance evidence with the n-grams that the trained CNN model uses to make a prediction.

In block 704, the computer can condition a plurality of pre-defined evidence. For example, the stop words in the pre-defined evidence and the group of n-grams can be first removed. The computer can use both the pre-defined evidence that conform to the coding rules for a clinical code and the group of n-grams identified by the max-pooling layer of a trained CNN model that predicted the clinical code to remove the stop words.

In block 706, the word mover's distance (WMD) similarity is calculated between each pre-defined evidence and each n-gram from the group of n-grams in order to measure the semantic similarity between two text spans of potentially different lengths. The Word Mover's Distance (WMD) is a suitable metric for this purpose. The WMD is calculated using word embeddings. Word embedding is a feature learning technique in natural language processing.

From a text corpus, words are learned and mapped to multi-dimensional vectors of real numbers. It has shown that the learned word vectors can capture semantic meanings and linguistic regularities. With word embeddings, a text span can be represented as a set of points (i.e., words appeared in the text span) in a multi-dimensional space. Similarity between two text spans can be calculated as the minimal distance to move one “cloud” of points (i.e., words) to overlap another “cloud” of points. This distance is coined as the Word Mover's Distance and is described by Kusner, M. J., Sun, Y., Kolkin, N. I., and Weinberger, K. Q., From word embeddings to document distances, Proceedings of the 32^{nd} International Conference on Machine Learning, 2015.

The WMD is a measure of distance, which can be conceived as the inverse of similarity. For example, the shorter the distance the higher the similarity. The WMD can be converted to a similarity measure by the following formula: 1/(1+WMD). Note that the WMD for two identical text spans is 0, which is converted to a similarity score of 1 using this formula. The WMD for two completely different text spans is a very large number, which is converted to a similarity score close to 0 by the formula. Various libraries can compute the WMD similarity between two input text spans such as gensim.

In block 708, the computer can rank the n-grams according to the similarity score (e.g., the calculated WMD similarity scores), with higher ranks for higher similarity scores. The top n ranked n-grams from the group of n-grams can be extracted as the compliance evidence for the predicted code.

### List of Illustrative Embodiments

1. A system comprising:

one or more computers, comprising:

a processing circuitry; and

a memory storing instructions which, when executed by the processing circuitry, cause the processing circuitry to perform operations comprising:
determining, using the processing circuitry operating a neural network model, a labeled classification from a collection of documents corresponding to an encounter, the collection of documents comprises a first plurality of n-grams;
determining an evidence score for an n-gram based on contribution of the n-gram to the labeled classification;
ranking at least some of the first plurality of n-grams based on the evidence score for each n-gram;
selecting an n-gram from the first plurality of n-grams as an explanation evidence based on the ranking; and
performing at least one operation in response to selecting the n-gram as the explanation evidence.
   2. The system of embodiment 1, further comprising a display, wherein performing at least one operation comprises presenting the explanation evidence on the display.
   2a. The system of embodiment 2, wherein the one or more computers includes a client device and a web server.
   2b. The system of any of the preceding embodiments, wherein the client device is configured to transmit the collection of documents or the first plurality of n-grams to the web server.
   2c. The system of any of the preceding embodiments, wherein the client device is configured to pre-process the collection of documents to obtain the first plurality of n-grams.
   2d. The system of any of the preceding embodiments, wherein the web server is configured to access the collection of documents or the first plurality of n-grams, and the performing at least one operation comprises transmitting indicia of the explanation evidence to the client device.
   2e. The system of any of the preceding embodiments, wherein the client device stores the collection of documents locally and uses the indicia of the explanation evidence to visually identify the n-gram in the explanation evidence within the collection of documents.
   3. The system of embodiment 2, wherein the display is on a client device.
   4. The system of embodiment 2, wherein the presenting the explanation evidence on the display comprises visually identifying the explanation evidence within the collection of documents.
   5. The system of any of the preceding embodiments, wherein the one or more computers comprise a user interface configured to be projected by the display, the explanation evidence is presented on the user interface with the n-gram highlighted.
   6. The system of any of the preceding embodiments, wherein the neural network model is a convolutional neural network model.
   7. The system of any of the preceding embodiments, wherein the labeled classification is a clinical code and the encounter is a medical encounter between a patient and a clinician.
   8. The system of any of the preceding embodiments, wherein determining a labeled classification from the collection of documents comprises:
accessing the collection of documents corresponding to an encounter;
determining, using the processing circuitry, a vector representation of the first plurality of n-grams using a convolutional neural network (CNN) model; and
determining, using the processing circuitry, a labeled classification based on the vector representation.
   9. The system of embodiment 8, wherein determining the vector representation comprises:

performing, at a convolutional layer, a convolutional operation on the first plurality of n-grams using a plurality of convolution kernels and a feature extraction operation to obtain a matrix of features;

performing, at a pooling layer, a pooling operation on the matrix of features to obtain the vector representation for the labeled classification.

10. The system of embodiment 9, wherein determining the labeled classification comprises selecting a group of n-grams based on the pooling operation.
11. The system of any of the preceding embodiments, wherein performing the convolutional operation comprises:

inputting an n-gram and a weight associated with the n-gram into a neural network node; and

using an activation function on the n-gram and the weight to obtain a feature.

12. The system of any of the preceding embodiments, wherein determining the evidence score comprises:

identifying, for each vector representation associated with the labeled classification, a numerical value of the n-gram associated with the vector representation and the weight of the n-gram; and

determining the evidence score based on the numerical value of the n-gram and the weight of the n-gram.

13. The system of any of the preceding embodiments, wherein determining the evidence score comprises identifying a group of n-grams contributing to the labeled classification based on the n-grams in the pooling operation.
14. The system of any of the preceding embodiments, wherein the CNN model includes an input layer, a convolutional layer, and a pooling layer,

wherein determining the vector representation comprises:

applying a convolutional filter, at the convolutional layer, to the first plurality of n-grams to obtain a plurality of features; and

combining the plurality of features, at the pooling layer, to obtain the vector representation for the first plurality of n-grams; and

selecting a group of n-grams based on the vector representation to associate with the labeled classification.

15. The system of any of the preceding embodiments, wherein the CNN is pre-trained with a training set of data corresponding to a plurality of clinical codes, further comprising:

providing the training set of data to the processing circuitry,

apply the training set of data to the CNN, wherein the training set of data comprises labels corresponding to the labeled classification.

16. The system of embodiment 15, wherein providing the training set of data further comprises:

receiving a second labeled classification corresponding to the training set of data;

determining a second plurality of n-grams from the second labeled classification and associated data.

17. The system of any of the preceding embodiments, wherein the memory stores instructions which cause the processing circuitry to perform operations comprising:

receiving a training set of data comprising a plurality of pre-defined evidence which further comprises a second plurality of n-grams;

determining a similarity score based on a comparison of the plurality of pre-defined evidence with the explanation evidence; and

ranking the explanation evidence of a plurality of explanation evidence based on the similarity score.

18. The system of embodiment 17, wherein determining the similarity score uses a word movers distance between the second plurality of n-grams and the group of n-grams.
19. The system of embodiment 18, wherein the memory stores instructions which cause the processing circuitry to perform operations further comprising:

conditioning pre-defined evidence from the plurality of pre-defined evidence;

determining the similarity score based on a comparison between a pre-defined evidence and each n-gram from the group of n-grams;

extracting n-grams from the group of n-grams as a function of rank to form a group of compliance evidence.

20. The system of any of the preceding embodiments, wherein conditioning the pre-defined evidence comprises removing stop words in the pre-defined evidence.
21. The system of any of the preceding embodiments, wherein the memory stores instructions which cause the processing circuitry to perform operations further comprising presenting the group of compliance evidence on the display.
22. The system of any of the preceding embodiments, wherein the memory stores instructions which cause the processing circuitry to perform operations further comprising: combining overlapping n-grams from the group of compliance evidence.
23. The system of any of the preceding embodiments, wherein the memory stores instructions which cause the processing circuitry to perform operations further comprising:

accessing plurality of clinical codes and a training set of data, the clinical codes are labels for at least some of the training set of data, the training set of data comprising a second plurality of n-grams;

training the convolutional neural network (CNN) model with the labeled classification and the training set of data.

23a. The system of any of the preceding embodiments, wherein the neural network model is trained.
23b. The system of any of the preceding embodiments, wherein the determining an evidence score occurs substantially simultaneously with determining a labeled classification.
23c. The system of any of the preceding embodiments, wherein the determining a labeled classification of 10 documents occurs in less than 1 second.
23d. The system of any of the preceding embodiments, wherein determining the evidence score of 10 documents occurs in less than 1 second.
24. A method, comprising:

accessing a collection of documents corresponding to an encounter, a document in the collection comprises a first plurality of n-grams;

applying the first plurality of n-grams to a neural network model to obtain a labeled classification for the document;

determining an explanation evidence based on a group of n-grams existing after a pooling operation in a pooling layer of the neural network model; and

displaying the explanation evidence relevant to determination of the labeled classification by the neural network model, the explanation evidence is a group of n-grams.

25. The method of embodiment 24, wherein the collection of documents is stored on a client device.
26. The method of embodiment 25, wherein displaying the explanation evidence comprises visually identifying the explanation evidence within the document on the client device, wherein the collection of documents is stored on the client device.
27. The method of any of the preceding embodiments, wherein the neural network model is hosted on one or more computers.
28. The method of any of the preceding embodiments, wherein the neural network model is a convolutional neural network model.
29. The method of embodiment 28, wherein the convolutional neural network model is pre-trained with a training set of data that includes pre-determined labeled classifications.
30. The method of any of the preceding embodiments, wherein the labeled classification corresponds to a clinical code and the encounter is a medical encounter between a patient and a clinician.
31. The method of any of the preceding embodiments, wherein determining a labeled classification from the collection of documents comprises:
accessing the collection of documents corresponding to a medical encounter, the collection of documents comprises a first plurality of n-grams;
determining, using processing circuitry, a vector representation of the first plurality of n-grams using a convolutional neural network (CNN) model; and
determining, using the processing circuitry, a labeled classification based on the vector representation.
   32. The method of embodiment 31, wherein determining the vector representation comprises:

performing, at the convolutional layer, a convolutional operation on the first plurality of n-grams using a plurality of convolution kernels and a feature extraction operation to obtain a matrix of features;

performing, at a pooling layer, a pooling operation on the matrix of features to obtain the vector representation for the labeled classification.

33. The method of embodiment 32, wherein performing a convolutional operation comprises:

inputting an n-gram and the weight associated with the n-gram into a neural network node; and

using an activation function on the n-gram and the weight to obtain a feature.

34. The method of embodiment 33, wherein determining the evidence score comprises:

identifying, for each vector representation associated with the labeled classification, a numerical value of the n-gram associated with the vector representation and the weight of the n-gram; and

determining the evidence score based on the numerical value of the n-gram and the weight of the n-gram.

35. The method of embodiment 31, wherein the neural network model is pre-trained with a training set of data corresponding to a plurality of clinical codes, further comprising:

providing the training set of data to the processing circuitry,

apply the training set of data to the neural network model, wherein the training set of data comprises labels corresponding to the labeled classification.

36. The method of embodiment 31, wherein the memory stores instructions which cause the processing circuitry to perform operations further comprising:

conditioning pre-defined evidence from a plurality of pre-defined evidence;

determining a similarity score based on a comparison between a pre-defined evidence and each n-gram from the group of n-grams;

extracting n-grams from the group of n-grams as a function of rank to form a group of compliance evidence.

37. The method of embodiment 36, wherein determining the similarity score uses a word movers distance between n-grams in the pre-defined evidence and the group of n-grams.
38. The method of embodiment 37, wherein the memory stores instructions which cause the processing circuitry to perform operations further comprising:

conditioning pre-defined evidence from the plurality of pre-defined evidence;

determining the similarity score based on a comparison between a pre-defined evidence and each n-gram from the group of n-grams;

extracting n-grams from the group of n-grams as a function of rank to form a group of compliance evidence.

39. The method of embodiment 38, wherein conditioning the pre-defined evidence comprises removing stop words in the pre-defined evidence.
40. The method of embodiment 37, wherein the memory stores instructions which cause the processing circuitry to perform operations further comprising presenting the group of compliance evidence on the display.
41. A non-transitory computer-readable storage medium including instructions that, when processed by a computer, configure the computer to perform the method of embodiment 24.

What is claimed is:

1. A system comprising:
one or more computers, comprising:
a processing circuitry; and
a memory storing instructions which, when executed by the processing circuitry, cause the processing circuitry to perform operations comprising:
determining, using the processing circuitry operating a neural network model, a labeled classification from a collection of documents corresponding to an encounter, the collection of documents comprises a first plurality of n-grams;
determining an evidence score for an n-gram based on contribution of the n-gram to the labeled classification;
ranking at least some of the first plurality of n-grams based on the evidence score for each n-gram;
selecting an n-gram from the first plurality of n-grams as an explanation evidence based on the ranking; and
performing at least one operation in response to selecting the n-gram as the explanation evidence.

2. The system of claim 1, further comprising a display, wherein performing at least one operation comprises presenting the explanation evidence on the display.

3. The system of claim 2, wherein the display is on a client device.

4. The system of claim 2, wherein the presenting the explanation evidence on the display comprises visually identifying the explanation evidence within the collection of documents.

5. The system of claim 1, wherein determining a labeled classification from the collection of documents comprises:
accessing the collection of documents corresponding to an encounter;
determining, using the processing circuitry, a vector representation of the first plurality of n-grams using a convolutional neural network (CNN) model; and
determining, using the processing circuitry, a labeled classification based on the vector representation.

6. The system of claim 5, wherein determining the vector representation comprises:
performing, at a convolutional layer, a convolutional operation on the first plurality of n-grams using a plurality of convolution kernels and a feature extraction operation to obtain a matrix of features;
performing, at a pooling layer, a pooling operation on the matrix of features to obtain the vector representation for the labeled classification.

7. The system of claim 6, wherein determining the labeled classification comprises selecting a group of n-grams based on the pooling operation.

8. The system of claim 6, wherein performing the convolutional operation comprises:
inputting an n-gram and a weight associated with the n-gram into a neural network node; and
using an activation function on the n-gram and the weight to obtain a feature.

9. The system of claim 6, wherein determining the evidence score comprises:
identifying, for each vector representation associated with the labeled classification, a numerical value of the n-gram associated with the vector representation and the weight of the n-gram; and
determining the evidence score based on the numerical value of the n-gram and the weight of the n-gram.

10. The system of claim 9, wherein determining the evidence score comprises identifying a group of n-grams contributing to the labeled classification based on the n-grams in the pooling operation.

11. The system of claim 5, wherein the CNN model includes an input layer, a convolutional layer, and a pooling layer,
wherein determining the vector representation comprises:
applying a convolutional filter, at the convolutional layer, to the first plurality of n-grams to obtain a plurality of features; and
combining the plurality of features, at the pooling layer, to obtain the vector representation for the first plurality of n-grams; and
selecting a group of n-grams based on the vector representation to associate with the labeled classification.

12. The system of claim 1, wherein the memory stores instructions which cause the processing circuitry to perform operations comprising:
receiving a training set of data comprising a plurality of pre-defined evidence which further comprises a second plurality of n-grams;
determining a similarity score based on a comparison of the plurality of pre-defined evidence with the explanation evidence; and
ranking the explanation evidence of a plurality of explanation evidence based on the similarity score.

13. The system of claim 12, wherein the memory stores instructions which cause the processing circuitry to perform operations further comprising:
conditioning pre-defined evidence from the plurality of pre-defined evidence;
determining the similarity score based on a comparison between a pre-defined evidence and each n-gram from the group of n-grams;
extracting n-grams from the group of n-grams as a function of rank to form a group of compliance evidence.

14. A method, comprising:
accessing, with one or more computers, a collection of documents corresponding to an encounter, a document in the collection comprises a first plurality of n-grams;
applying, with the one or more computers, the first plurality of n-grams to a neural network model to obtain a labeled classification for the document;
determining, with the one or more computers, an explanation evidence based on a group of n-grams existing after a pooling operation in a pooling layer of the neural network model; and
displaying, with the one or more computers, the explanation evidence relevant to determination of the labeled classification by the neural network model, the explanation evidence is a group of n-grams.

15. The method of claim 14, wherein the collection of documents is stored on a client device.

16. The method of claim 15, wherein displaying the explanation evidence comprises visually identifying the explanation evidence within the document on the client device, wherein the collection of documents is stored on the client device.

17. The method of claim 14, wherein determining a labeled classification from the collection of documents comprises:
accessing the collection of documents corresponding to a medical encounter, the collection of documents comprises a first plurality of n-grams;
determining, using processing circuitry, a vector representation of the first plurality of n-grams using a convolutional neural network (CNN) model; and
determining, using the processing circuitry, a labeled classification based on the vector representation.

18. The method of claim 17, wherein determining the vector representation comprises:
performing, at the convolutional layer, a convolutional operation on the first plurality of n-grams using a plurality of convolution kernels and a feature extraction operation to obtain a matrix of features;
performing, at a pooling layer, a pooling operation on the matrix of features to obtain the vector representation for the labeled classification.

19. The method of claim 18, wherein performing a convolutional operation comprises:
inputting an n-gram and the weight associated with the n-gram into a neural network node; and
using an activation function on the n-gram and the weight to obtain a feature.

20. The method of claim 14, wherein determining the evidence score comprises:
identifying, for each vector representation associated with the labeled classification, a numerical value of the n-gram associated with the vector representation and the weight of the n-gram; and
determining the evidence score based on the numerical value of the n-gram and the weight of the n-gram.
